(19) United States
(12) Patent Application Publication
(10) Pub. No.: US 2008/0165260 A1
(43) Pub. Date: Jul. 10, 2008

(54) IMAGE SEARCHING ON DIGITAL CAMERAS AND EXTENDING APPLICATIONS

(75) Inventor: Chandrasekhar Narayanaswami, Wilton, CT (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/621,159

(22) Filed: Jan. 9, 2007

(51) Int. Cl. H04N 5/76

(52) U.S. Cl. 348/231.3

(57) ABSTRACT

A digital camera device, aspects of the device comprising an image capturing component, and an image-processing component, wherein the identifier writing component is configured to generate an identifier and associate the identifier with a captured image. Further aspects of the device comprise a memory for the storage of captured images and identifiers, a captured image associated identifier database, and an identifier output device, wherein the identifier output device is configured to output the identifier that has been associated with a captured image.

### BACKGROUND OF THE INVENTION

1. Field of the Invention

This invention relates to the searching and retrieval of images within the memory of a digital camera device, and particularly to the search and retrieval of images within a digital camera device by the use of unique image identifiers, wherein the unique image identifiers have been associated with a stored image.

2. Description of Background

Before our invention, in the event that an individual placed an item into the care of a custodial agent (e.g., placing luggage into the custody of a bellhop upon checking out from a hotel, checking a coat at a coat check in a restaurant, or presenting a car for valet parking, etc.) the individual would be given a token with a label to validate that the transfer of custodial care of an item had occurred. Further, a copy of the token would thereafter be attached to the item and stored. When the time came to retrieve the article, the individual would present the token to the custodial agent, and the agent would attempt to match the token with a token that has been associated with the item, and thereafter retrieve the item.

In many instances, the custodial agent has no idea what the article looks like, and therefore has to manually check the tokens that are associated with several items in the area in order to retrieve the correct item. The assumption being that articles with consecutive labels are kept in close vicinity, and that being so, a label directs the agent towards a particular location for an item. This search process could be considerably simplified if the agent had an image of the item for which they were looking.

The advent of cost efficient multi-mega pixel digital cameras help to serve as aids to assist in an efficient item cataloging and retrieval technique. Thus, a digital camera device could be used to capture pictures of articles that have been deposited with a custodian for safekeeping. The pictures can then be used to improve the speed of retrieval of an item, in addition to helping confirm that the correct article is being retrieved and returned to the owner. Generally, digital cameras have limited input device capabilities, but have the potential to store several thousands of images. Therefore, a method is needed to quickly and efficiently catalog and retrieve such stored digital images.

### SUMMARY OF THE INVENTION

The shortcomings of the prior art are overcome and additional advantages are provided through the provision of a digital camera that comprises an identifier input and decoding component. Aspects of the device comprise an image-capturing component, and an identifier processing component, wherein the identifier processing component is configured to generate an identifier and associate the identifier with a captured image. Further aspects of the device comprise a memory component for the storage of captured images and identifiers, a captured image associated identifier database, and an identifier output component, wherein the identifier output component is configured to write an identifier that has been associated with a captured image.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A illustrates a front perspective of a digital camera that may be utilized within aspects of the present invention.

FIG. 1B illustrates a rear perspective of a digital camera that may be utilized within aspects of the present invention.

FIG. 1C illustrates one example of a digital camera capturing the image of an object.

FIG. 1D illustrates one example of a printout receipt that may be printed within aspects of the present invention.

FIG. 2 illustrates one example of functional components that may be implemented within aspects of the present invention.

FIG. 3A illustrates one example of the communication between a primary and secondary device over a network within aspects of the present invention.

FIG. 3B illustrates one example of the communication between a primary device, a secondary device, and a remotely located database, over a network within aspects of the present invention.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views.

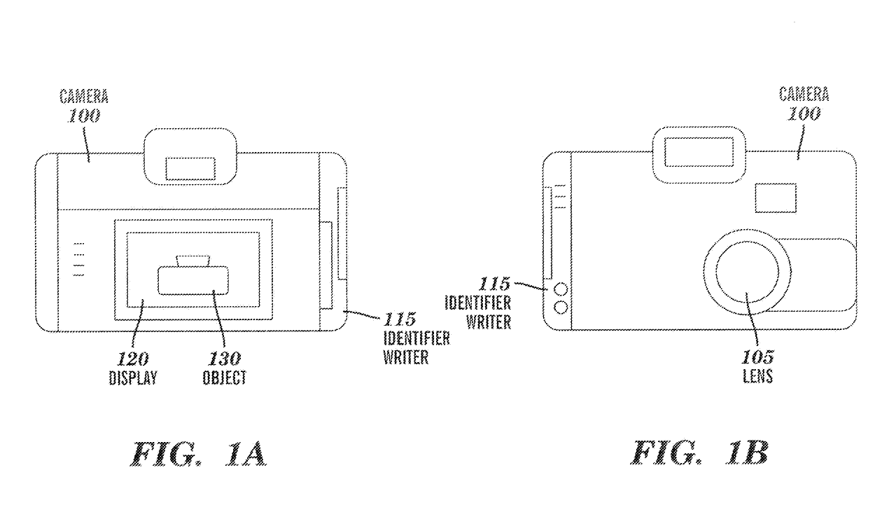

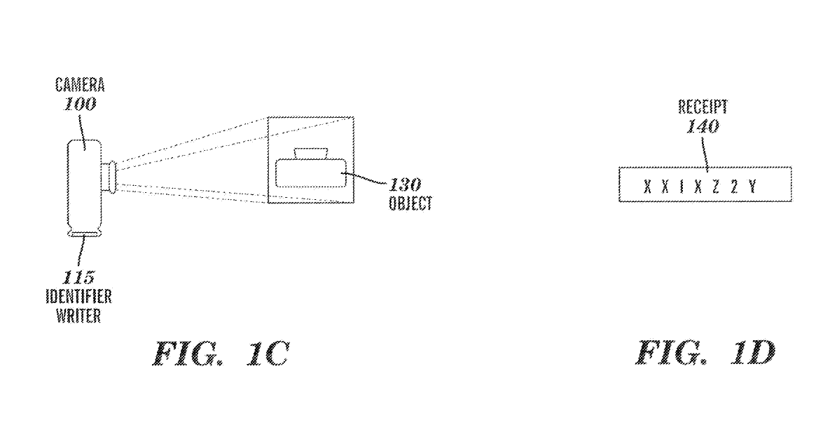

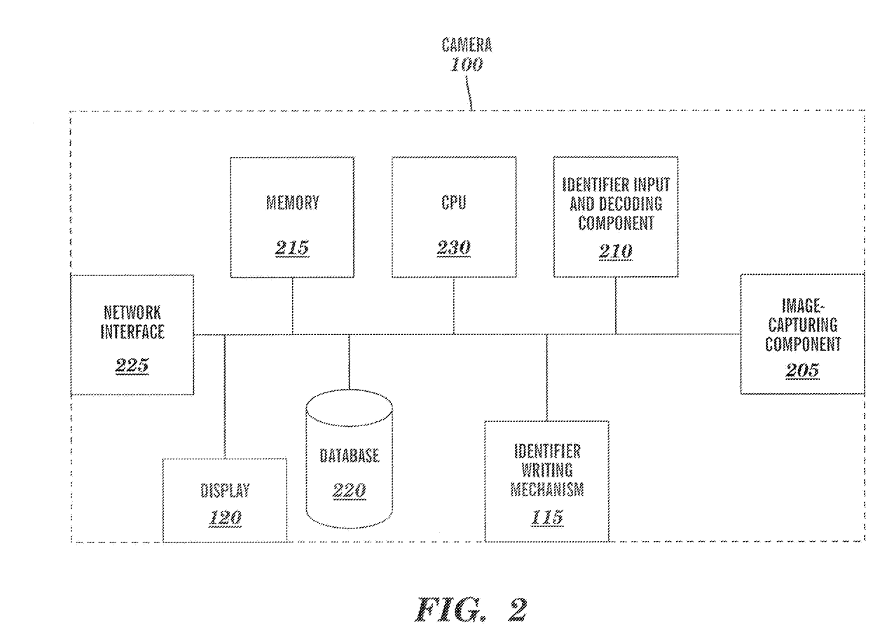

Turning now to the drawings in greater detail. FIGS. 1A and 1B show illustrations of a front and rear perspective a digital camera 100, wherein the digital camera comprises a CPU 230, a lens mechanism 105, a identifier writing mechanism 115, and a display device 120. For illustrative purposes only, the display device 120 displays a visual representation of an object 130, the image of said object having been captured by use of the lens mechanism 105 (FIG. 1C). As shown in FIG. 2, the camera 100 further comprises an image-capturing component 205, an identifier input and decoding component 210, a memory 215, a database 220 and a network interface 225.

Within aspects of the present invention, a camera operator, to take a picture of an object 130, uses the digital camera 100. After the image of the object 130 has been captured and saved into the memory 215 by the digital camera 100, the camera operator has the option of utilizing the integrated identifier writer 115 to generate a receipt 140 (FIG. 1D), confirming that the image of the object 130 has been captured and saved to memory 215. The receipt 140 comprises a graphic representation of a unique identifier, the unique identifier being generated and associated with a digital picture within the digital camera 100 as part of the functionality of the identifier input and decoding component 210. The unique identifier can comprise any numeral, text , or graphically represented image (e.g., barcodes, randomly generated character strings, etc . . . ).

Within further aspects of the present invention the identifier can be written in one of several ways. Yet further aspects of the present invention provide for the identifier to be printed on a printing medium. Additional aspects of the present invention provide methods for writing the identifier, wherein the writing operation comprises electronically writing the identifier to a magnetic stripe, a RFID tag, or to a portable memory card. Further, the identifier can be electronically transmitted over a network interface to a networked device such as a cell phone, PDA, or as an SMS message, or email message.

The identifier can be read in one of may ways. The identifier could be scanned with a bar code, magnetic, or RFID reader. The identifier could also be imaged by a camera and optical recognition techniques be used to decipher the identifier. The identifier could also be transferred electronically from another device such as a user's cell phone or PDA.

Yet further aspects of the present invention comprise and identifier input and decoding component, wherein the identifier input and decoding component is configured to read a captured image of the printed graphic image of an identifier, a display device for displaying the captured image that has been associated the indentifier, and a network interface.

In further aspects of embodiments of the present invention, the receipt 140 could be electronically written to a magnetic stripe, a storage card, or a RFID tag. In additional embodiments, the receipt 140 can be electronic, and transmitted electronically by an SMS or email message, or transferred electronically to another device that may present the receipt later review. Protective methods may be incorporated to make it difficult to duplicate receipts by adding security mechanisms possibly including cryptography, watermarking, etc.

The unique identifiers that are generated within aspects of the present invention are subsequently stored in an identifier database 220, wherein the identifiers can be accessed at later time periods to assist in image retrieval search function that can be accomplished within aspects of the present invention. In further aspects of the present invention, the identifier database 220 can also be located at a remote location, wherein the database 220 can be accessed via the network interface 225 of the camera 100.

In the event that a camera device 100 operator desires to retrieve a specific image that is saved within the camera's 100 memory 215 at a later time period, aspects of the present invention allow for the camera 100 operator to read and decode the identifier that is printed on the receipt 140, and thereafter locate and display at the display device 120 to the operator the image that has been associated with the identifier. This stored image retrieval function is facilitated by the use of the identifier input and decoding component 210. The image of the receipt 140 is input to the identifier input and decoding component 210 via the image-capturing component 205, wherein an identifier is printed upon a receipt. The identifier input and decoding component 210 reads the identifier that is printed upon the receipt 140 to obtain the associated identifier for an image. Thereafter, the image identifier is used to access the identifier database 220 in order to ascertain the location of the image that has been associated with the identifier within the memory 215.

In further aspects of embodiments, stored images can be encrypted to further ensure for the security and confidentiality of a custodial item. Stored images are encrypted with keys that are generated from the identifiers that are associated with respective images. Further, an image can only be decrypted upon the presentation of an identifier to a custodial agent. In this instance, the identifier contains the key that is necessary to decrypt the image that is associated with the identifier. In further aspects, the devices can be configured to automatically delete a retrieved image at a predetermined time event after the image has been accessed and decrypted.

As an example, in a real-life scenario as presented above, an owner of an article (e.g., the object 130) deposits the article into the custody of a service attendant for safekeeping. The attendant thereafter uses a digital camera device 100 with an integrated identifier writer 115 that is configured, in one aspect of the present invention, to print unique identifiers, and to capture an image of the article for identification purposes. The camera 100, optionally associates a unique identifier with the captured image of the article, and thereafter prints out a graphic representation of the unique identifier. The identifier can later be read (i.e., photographed by the camera, or read via a barcode, magnetic strip or RFID tag reader) and decoded in order to help retrieve the image corresponding to the graphic code.

The camera device 100 requires no other data entry, and the entire image capturing/identifier generating process is automated within the camera device 100. The unique identifier is given to the owner of the article as a receipt 140. At the time of the retrieval of the deposited article, the owner provides the receipt to the service attendant. Thereafter, the attendant uses the camera 100 to read the identifier on receipt 140. Upon the capture and recognition the identifier, the camera 100 searches its image collection that is stored in the memory 205 in an attempt to find the image that corresponds to the captured identifier. Upon the locating of the stored image, the image is fetched from the camera's 100 memory storage 215 and displayed on the camera display screen 120. Thereafter, the attendant can use the displayed image of the article to quickly find the actual stored article. In further aspects of the present invention, a camera device 100 operator can alternatively transfer the image of the article to a larger display device, therefore presenting a larger and larger version of the image on a bigger screen in order to look at a more detailed display of the image to the camera device 100 operator. Yet further, the camera 100 may also transfer the images to a repository that is physically closer or more easily accessible to the operator at the time of article retrieval. In this instance, the identifier can be read and decoded by a computing system that is conveniently accessible to the operator.

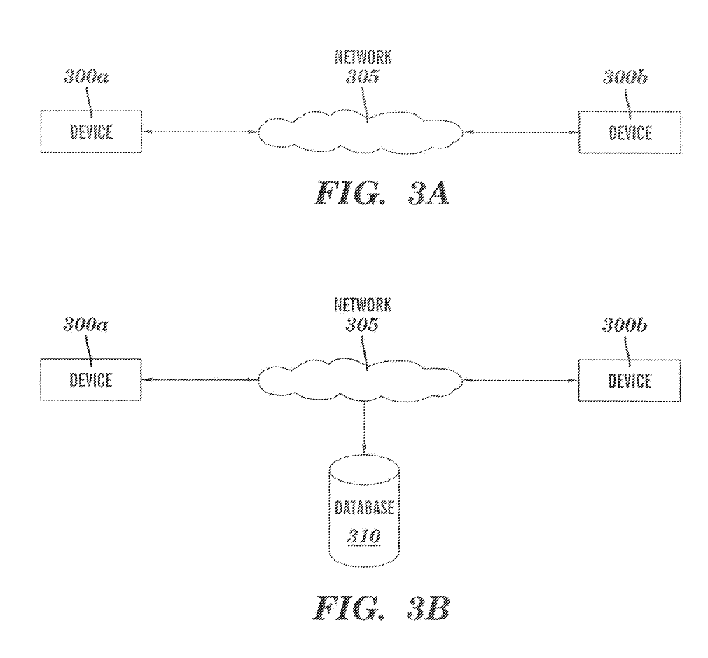

FIG. 3A illustrates an additional aspect of the present invention that provides for the networking of image capturing and display devices. As shown in FIG. 3A, individual camera devices (300a, 300b) have the capability to search and retrieve images from other networked devices via a network interface (not shown). In the instance that an identifier receipt is presented for recognition at a device 300a, 300b and the device 300a, 300b determines that the identifier reference that is associated with an image is not stored locally, then the device 300a, 300b can query a remotely located identifier database 305 (FIG. 3B), in order to determine where an image that corresponds to the identifier is stored. Once the image that is associated with the processed identifier is recognized, the device 300a, 300b can search for the image in the stored memory of any networked device 300a, 300b.

In another example, a digital camera 100 at an airline could take pictures of the passenger's bags and suitcases at the time the passenger checks-in, wherein the pictures are to be used later to trace and identify the passenger's bags. The identifier 140 could be printed on the passenger's boarding pass, or transferred to a mobile communication device that is owned by the passenger, or additionally stored in a baggage processing system.

In yet further aspects of the present invention, the functional aspects and components of the digital camera can be comprised within other devices (e.g., a laptop PC, kiosk, PDA, mobile communication devices, etc . . . ), wherein turn these devices can be networked and compatibly accomplish the disclosed search and retrieval function that are associated with aspects of the camera 100.

Aspects of an embodiment of the present invention are directed to a digital camera that comprises an integrated printer, wherein the printer is enabled to print unique identifiers (e.g., barcodes, generated character strings, etc . . . ) that are associated with images that have been captured by the digital camera upon a printing medium. For example, in the event that the digital camera is used to take a picture of an object, a camera operator has the option to print out a confirmation receipt after the picture has been captured and saved by the digital camera. The receipt comprises a visual indication of a unique identifier, wherein the unique identifier is generated and associated with the digital picture within the digital camera.

In the event that a device operator desires to retrieve a specific image that is saved within the device at a later time period, aspects of the present invention allow for a device user to read an identifier that is printed upon a receipt, and thereafter locate and display to the user the image that has been associated with the identifier. Additional aspects of the present invention provide for the networking of image capturing and display devices, wherein the devices have the capability to search and retrieve images from networked devices.

The capabilities of the present invention can be implemented in software, firmware, hardware or some combination thereof.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed:

1. A digital camera device, comprising:
an image capturing component;
an identifier writing component, wherein the identifier writing component is configured to generate an identifier, and associate the identifier with a captured image;
a memory for the storage of captured images and identifiers that have been associated with a captured image;
a captured image associated identifier database;
a identifier output component, wherein the identifier output component is configured to write an identifier that has been associated with a captured image;
an identifier input and decoding component, wherein the identifier input and decoding component is configured to read an identifier;
a display device for displaying the captured image that has been associated the identifier; and
a network interface.

2. The device of claim 1, wherein the identifier output component is a printing device, the printing device being configured to print upon a printing medium a graphic image of the identifier that has been associated with a captured image.

3. The device of claim 1, wherein the identifier input and output components comprise magnetic writing systems.

4. The device of claim 1, wherein the identifier input, and identifier output components comprise RFID tag writing systems.

5. The device of claim 1, wherein the identifier output system utilizes SMS messaging to deliver identifiers.

6. The device of claim 1, wherein the identifier output system utilizes email messaging to deliver identifiers.

7. The device of claim 1, wherein the identifier is used to assist in retrieving the captured image that is associated with the identifier from the memory device.

8. The device of claim 2, wherein the optically recognized captured image of the printed graphic image of the identifier is used to assist in retrieving the captured image that is associated with the identifier from the memory device.

9. The device of claim 2, wherein the identifier comprises a bar code.

10. The device of claim 2, wherein the identifier comprises a generated string of characters.

11. The device of claim 1, wherein identifier is an electronic message.

12. The device of claim 1, wherein the identifier is delivered to portable device.

13. The device of claim 1, wherein the image is further encrypted with a key that is generated using the identifier that is associated with the image.

14. The device of claim 1, wherein the captured image associated identifier database can be situated at a remote location.

15. The device of claim 1, wherein the captured image associated identifier database can be accessed from a remotely located secondary device.

16. The device of claim 1, wherein the captured images stored within the device can be accessed from a remotely located secondary device.

17. The device of claim 1, wherein the device is configured to electronically communicate with the captured image associated identifier database of a secondary device.

18. The device of claim 1, wherein the device is configured to access and retrieve the images that are stored at a secondary device.

19. The device of claim 15, wherein the remotely located secondary device comprises a laptop PC, kiosk, PDA, or mobile communication device.

20. The device of claim 16, wherein the remotely located secondary device comprises a laptop PC, kiosk, PDA, mobile communication device.
